(19) United States
(12) Patent Application Publication
(10) Pub. No.: US 2011/0315330 A1
(43) Pub. Date: Dec. 29, 2011

(54) PIVOTING LIGHT SHELF ASSEMBLY FOR DAYLIGHTING AN INTERIOR SPACE

(76) Inventors: Chadrick James Huff, Arvada, CO (US); James Craig Huff, Westminster, CO (US)

(21) Appl. No.: 13/006,916

(22) Filed: Jan. 14, 2011

Related U.S. Application Data
(60) Provisional application No. 61/359,051, filed on Jun. 28, 2010.

(51) Int. Cl. E06B 9/24

(52) U.S. Cl. 160/368.1

(57) ABSTRACT

A light shelf assembly includes a light shelf with pins extending laterally outward from a lateral edge, and a mounting bracket for attachment to a building structure adjacent to a window. The mounting bracket has a first track segment for initial insertion of the pins into the mounting bracket. The mounting bracket also includes a second track segment enabling one of the pin to slide between a first position in which the light shelf is held in a substantially horizontal position, and a second position in which the light shelf pivots downward.

### RELATED APPLICATION

The present application is based on and claims priority to the Applicant's U.S. Provisional Patent Application 61/359,051, entitled “Pivoting Light Shelf Assembly For Daylighting An Interior Space,” filed on Jun. 28, 2010.

### BACKGROUND OF THE INVENTION

### Field of the Invention

The present invention relates generally to the field of interior space illumination systems. More specifically, the present invention discloses a light shelf assembly having mounting brackets for attaching a light shelf adjacent to a window that allow the light shelf to be easily installed, and also to pivot downward for cleaning or maintenance.

### Statement of the Problem

It is a problem in the field of interior space illumination to provide a cost-effective mode of illumination that makes use of the incident sunlight without the need for complex systems or significant occupant intervention. For the purposes of this application, the term “daylighting” should be broadly construed to include any use of natural light from a clear sky (including daylight from both the solar disk and the sky dome) or overcast sky as an interior illuminant.

There is a need for systems that provide improved energy efficiency and environmental quality. One such example is the need to reduce the consumption of electricity for lighting. One option for reducing electricity consumption for lighting is to use daylight to illuminate occupied building spaces. The key to the widespread use of daylighting systems is in providing a system that is both inexpensive and easily applied to both new and existing buildings. In addition to the savings attributed to reduced electricity consumption, daylighting systems typically also result in increased productivity by the occupants of the illuminated space, reduced health problems evidenced by the occupants of the illuminated space and pollution reduction. There appears to be a strong correlation between the quality of the luminous environment and the overall health and productivity of the occupants. These ancillary benefits can produce savings that dwarf the savings attributable to electricity consumption reduction, since studies indicate that, over the life of the building, an overwhelming percentage of the operating cost of commercial space is the salaries of the occupants. Thus, any improvement in the performance of the occupants of the building space results in a significant economic benefit.

One such existing daylighting system is the traditional light shelf, which receives daylight through a window and redirects it onto the interior ceiling plane, thereby creating a useful source of interior illumination. The basic light shelf concept includes a number of wide flat elongated interior light shelves mounted adjacent to a window that extend into the interior space from the exterior wall of a building. Incident sunlight is reflected by the light shelf onto the ceiling of the interior space by the reflective top surface of the light shelf. The top surface of the light shelf is usually either horizontal or slightly sloped. The reflective finish of the top surface can either be diffusely reflective or specular.

The light shelf is typically oriented in a horizontal plane with its outer edge adjacent to the window. If multiple light shelves are employed, they can be stacked in a vertical arrangement similar to conventional blinds. This horizontal projection requires that the shelf be placed high enough so as not to interfere with building occupants. Typically, this is at a distance of seven feet or greater above the finished floor. This causes installations to be fairly close to ceiling levels (usually within four feet or less). Due to the close proximity of the installation to the ceiling, cleaning of the windows and the light shelf itself can be cumbersome for a fixed device. To ensure efficient collection of as much daylight as possible, both the light shelf and adjacent window should be periodically cleaned at such intervals as regular dusting or window washing. Thus, a need exists for a mounting bracket that enables a light shelf to be initially installed with minimal time and effort, and that also allows the light shelf to be easily rotated downward for cleaning and maintenance.

### Solution to the Problem

The present light shelf assembly includes mounting brackets that permits a single operator to easily rotate the light shelf downward (e.g., by about 80 degrees) exposing the reflective top surface of the light shelf and the window above for routine cleaning and maintenance. These mounting brackets also promote easy installation of the light shelf. The light shelf can be readily installed, rotated downward for cleaning, or raised to its horizontal position for normal use without requiring tools.

### SUMMARY OF THE INVENTION

This invention provides a light shelf assembly with a light shelf having two pins extending laterally outward from each lateral edge. Mounting brackets are attached to the building structure adjacent to a window. Each mounting bracket has a first track segment for initial insertion of the pins of the light shelf into the mounting bracket. Each mounting bracket also has a second track segment enabling one of the pins to pivot about the other pin by sliding between a first position in which the light shelf is held in a substantially horizontal position and a second position in which the light shelf pivots downward.

These and other advantages, features, and objects of the present invention will be more readily understood in view of the following detailed description and the drawings.

### BRIEF DESCRIPTION OF THE DRAWINGS

The present invention can be more readily understood in conjunction with the accompanying drawings, in which:

FIG. 1 is perspective view of the mounting bracket 30.

FIG. 2 is a side view of the mounting bracket 30 corresponding to FIG. 1.

FIG. 3 is a side cross-sectional view of the mounting bracket 30 attached to a window assembly 20, with a light shelf 10 positioned for initial installation.

FIG. 4 is a detail side cross-sectional view of the mounting bracket 30, the end of the light shelf 10, and a portion of the window assembly 20 corresponding to FIG. 3.

FIG. 5 is a side cross-sectional view corresponding to FIG. 3 after the pins 12, 14 of the light shelf 10 have been inserted into the diagonal first track 40 of the mounting bracket 30.

FIG. 6 is a detail side cross-sectional view corresponding to FIG. 5.

FIG. 7 is a side cross-sectional view with the light shelf 10 rotated downward into its maintenance position.

FIG. 8 is a detail side cross-sectional view corresponding to FIG. 7.

FIG. 9 is a side cross-sectional view with the light shelf 10 rotated upward to an initial horizontal position.

FIG. 10 is a detail side cross-sectional view corresponding to FIG. 9.

FIG. 11 is a side cross-sectional view of the light shelf 10 sliding between its positions in FIGS. 9 and 13.

FIG. 12 is a detail side cross-sectional view corresponding to FIG. 11.

FIG. 13 is a side cross-sectional view with the light shelf 10 locked in its horizontal position.

FIG. 14 is a detail side cross-sectional view corresponding to FIG. 13.

### DETAILED DESCRIPTION OF THE INVENTION

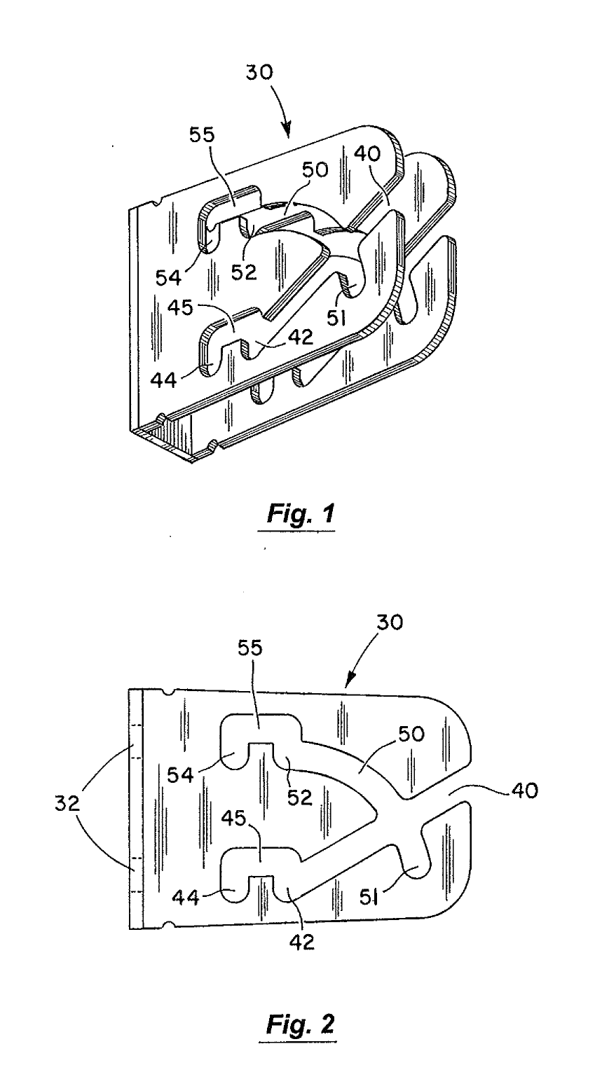

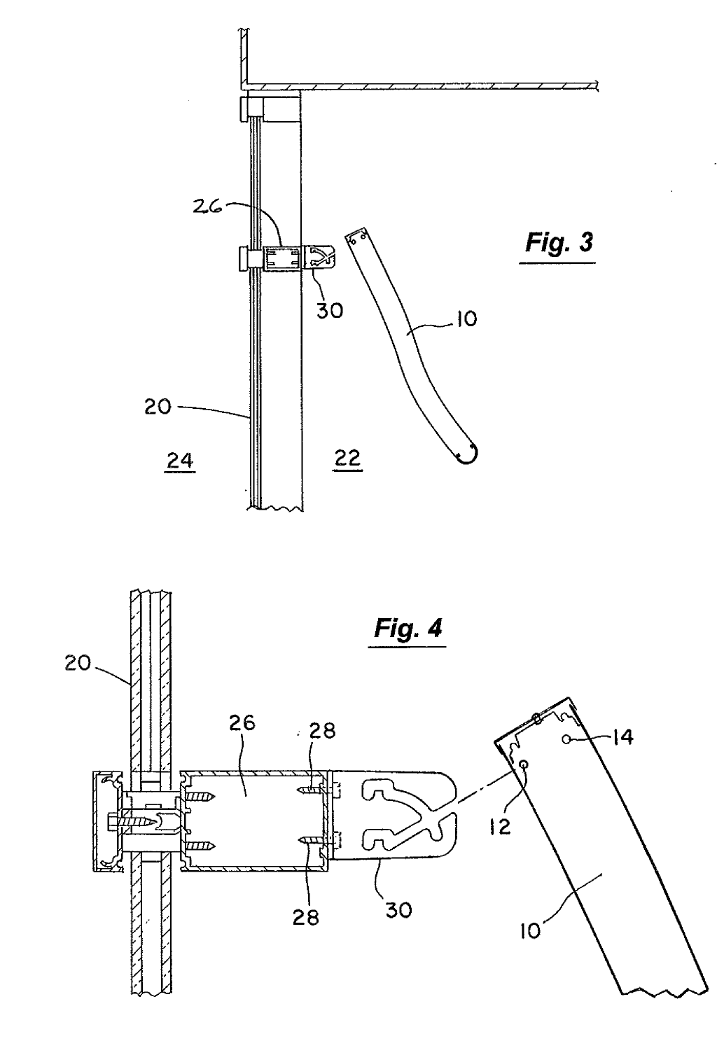

The major components of the present invention are a light shelf 10, and mounting brackets 30 used to attach the light shelf 10 adjacent to a window 20, FIGS. 1 and 2 illustrate an embodiment of a mounting bracket 30. This embodiment of the mounting bracket 30 is intended to accept light shelves from both sides, and be used as an intermediate mounting bracket in a series of light shelf installations. As shown in FIGS. 3 and 4, the mounting bracket 30 includes a base for attachment to a support member 26 secured to the building structure adjacent to a window 20. The mounting bracket 30 and light shelf are typically installed on the interior side 22 of the window 20, although they could be installed on the exterior 24 of the building.

As will be discussed in greater detail below, the mounting bracket 30 also includes a set of tracks designed to engage a complementary set of pins extending from the lateral edges of a light shelf 10. The pins of the light shelf 10 can be inserted in, and guided by these tracks in the mounting bracket 30, so that the pins slide to proper locations for insertion, maintenance or removal of the light shelf 10. For example, the light shelf 10 can employ two pins 12 and 14 (e.g., shoulder bolts) extending laterally outward from each lateral edge of the light shelf 10. These pins 12, 14 can be vertically aligned and spaced approximately 1¼ in. apart. This arrangement of pins 12, 14 positively holds the light shelf 10 in positions dictated by the mounting bracket design. Two pins 12, 14 are sufficient to constrain the light shelf to its desired path of motion and rotation along the tracks. However, more than two pins could be employed for each attachment to a mounting bracket.

As shown in FIGS. 1 and 2, the mounting bracket 30 can be fabricated as a steel clip having dimensions of approximately 2¼ in. H×3¼ in. D×⅞ in. W and approximately ⅛ in. thick. The mounting bracket 30 can be bent into a U-shaped channel creating an arrangement with two parallel ears projecting from the base of the mounting bracket 30. At least one of the projecting ears of the mounting bracket 30 has tracks to accept the pins 12, 14 extending from the light shelf 10 in sliding engagement. The tracks are sized to ensure free sliding movement of the pins 12, 14 along their paths. The mounting bracket 30 is depicted in the accompanying drawings as a bent metal clip. Alternatively, the mounting bracket 30 can be fabricated as a metal extrusion, although other materials may be used including wood or plastics.

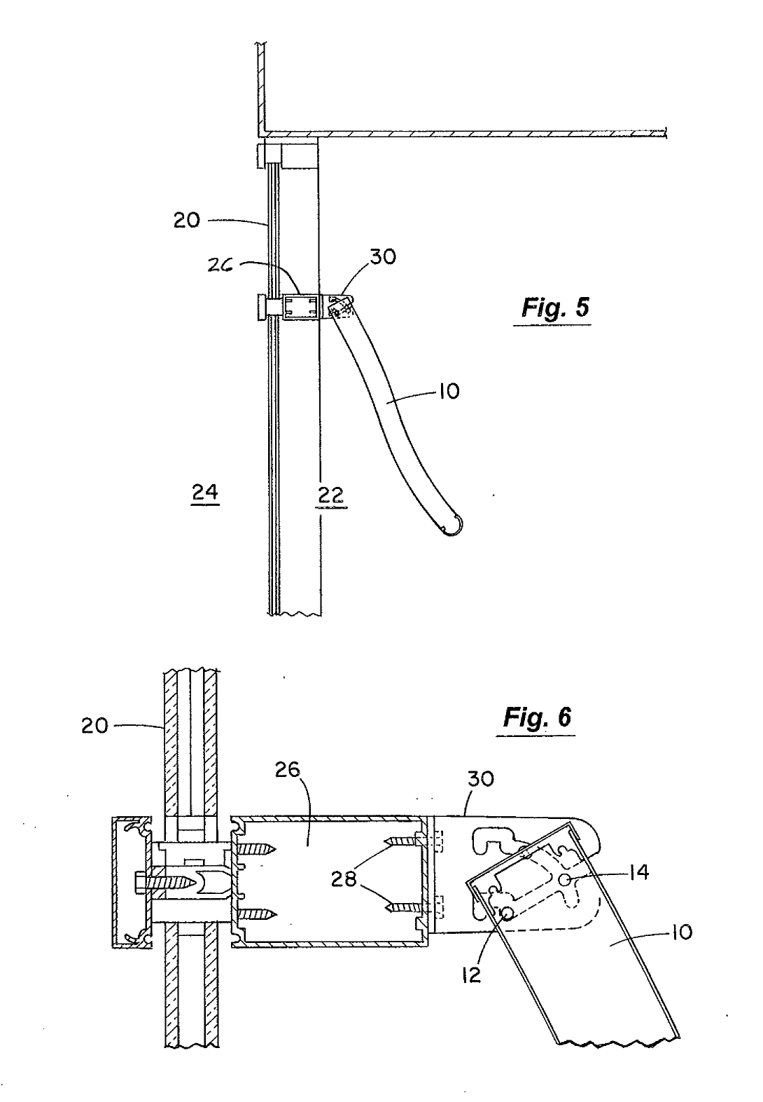

In the specific embodiment depicted in FIGS. 1 and 2, the tracks include an initial track segment 40 running diagonally downward from the periphery of the mounting bracket 30. This first track segment 40 engages both pins 12, 14 during initial installation of the light shelf 10 on the mounting bracket 30, and any subsequent removal of the light shelf 10. During installation, the lower pin 12 slides along the first track segment 40 until it becomes seated in the pivot stop 42 at the lower end of the first track segment 40. FIGS. 3 and 4 illustrate the proper angle of orientation for the light shelf 10 during installation (i.e., approximately 30 degrees from vertical). FIGS. 5 and 6 illustrate the light shelf pins 12, 14 inserted within the first track segment 40 of the mounting bracket 30.

Returning to FIGS. 1 and 2, the mounting bracket 30 also has second, curved track segment 50 that intersects the initial track segment 40 at a distance from the pivot stop 42 equal to the spacing between the pins 12 and 14. This second track segment 50 runs in a circular arc upward from this intersection point with the same radius, so the upper pin 14 can freely rotate about the lower pin 12 in the pivot stop 42. The range of rotation allowed by the second track segment 50 enables the light shelf 10 to pivot between a downward position and a horizontal position.

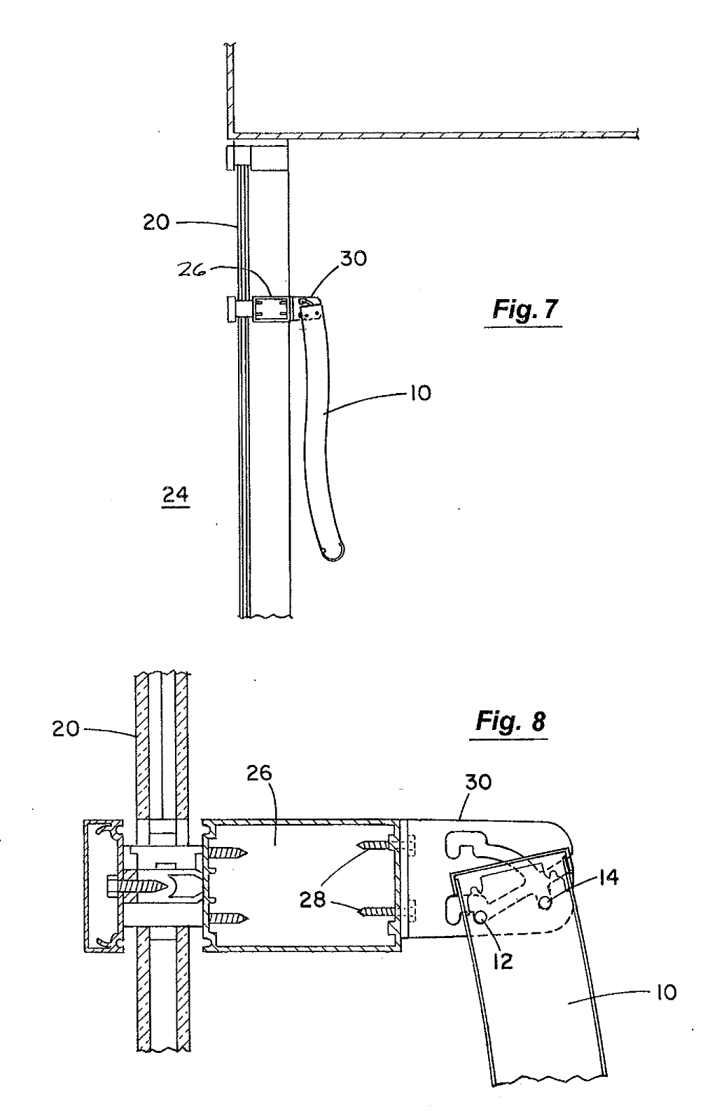

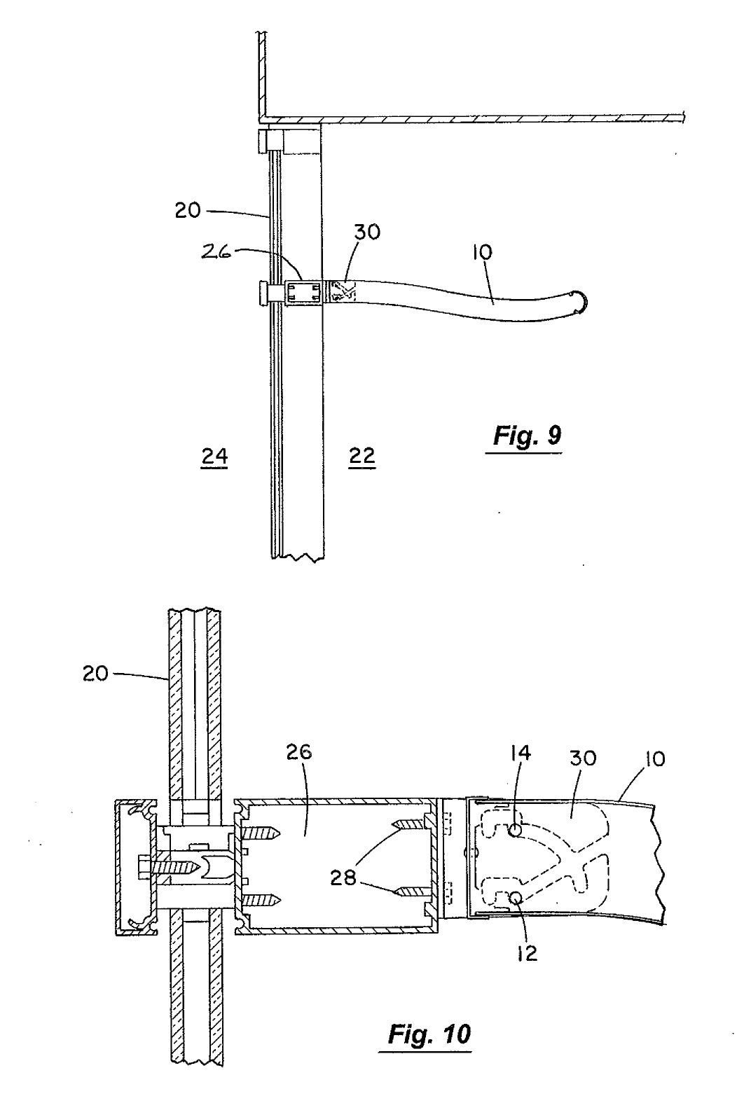

FIGS. 7 and 8 illustrate the maintenance position of the light shelf 10, rotated downward about 85 degrees from horizontal. The light shelf 10 is held in place by a lower stop 51 at the lower end of the second track segment 50, and is not allowed to rotate any further downward as pressure is applied for cleaning procedures such as by applying glass cleaner or dusting the light shelf 10. Notice the light shelf 10 will not slide out of the tracks in this position. FIGS. 9 and 10 illustrate the shelf rotated upward to its horizontal position. A stop 52 at the upper end of the second track segment 50 prevents further upward rotation of the light shelf 10 beyond the horizontal orientation in FIGS. 9 and 10.

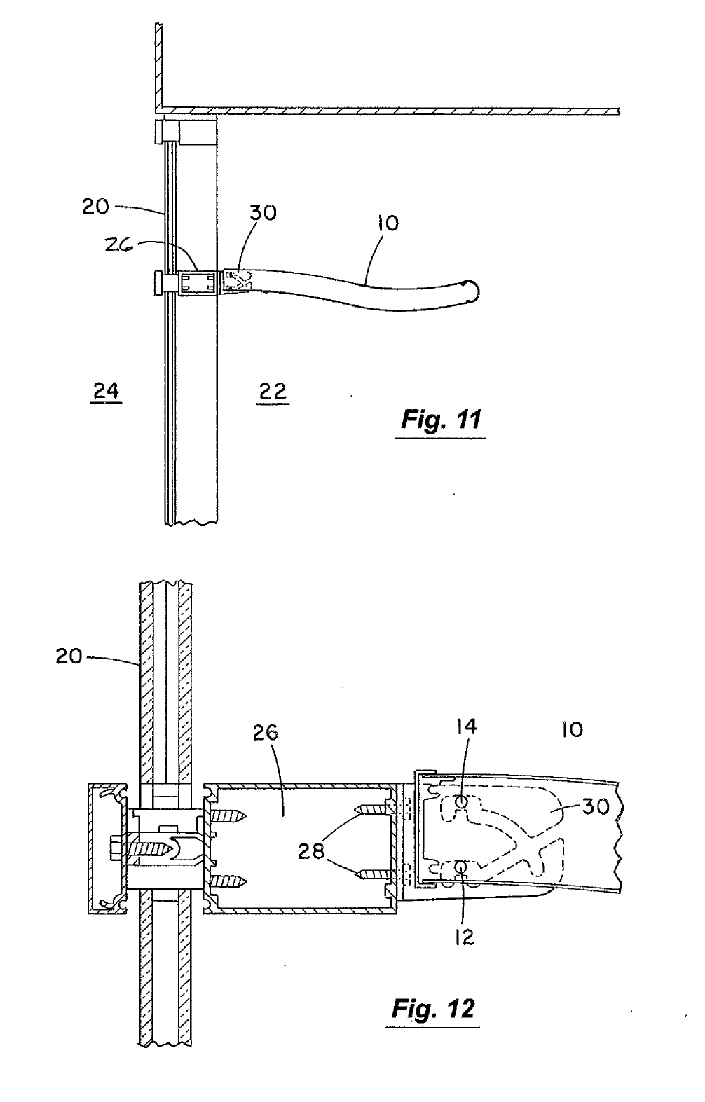

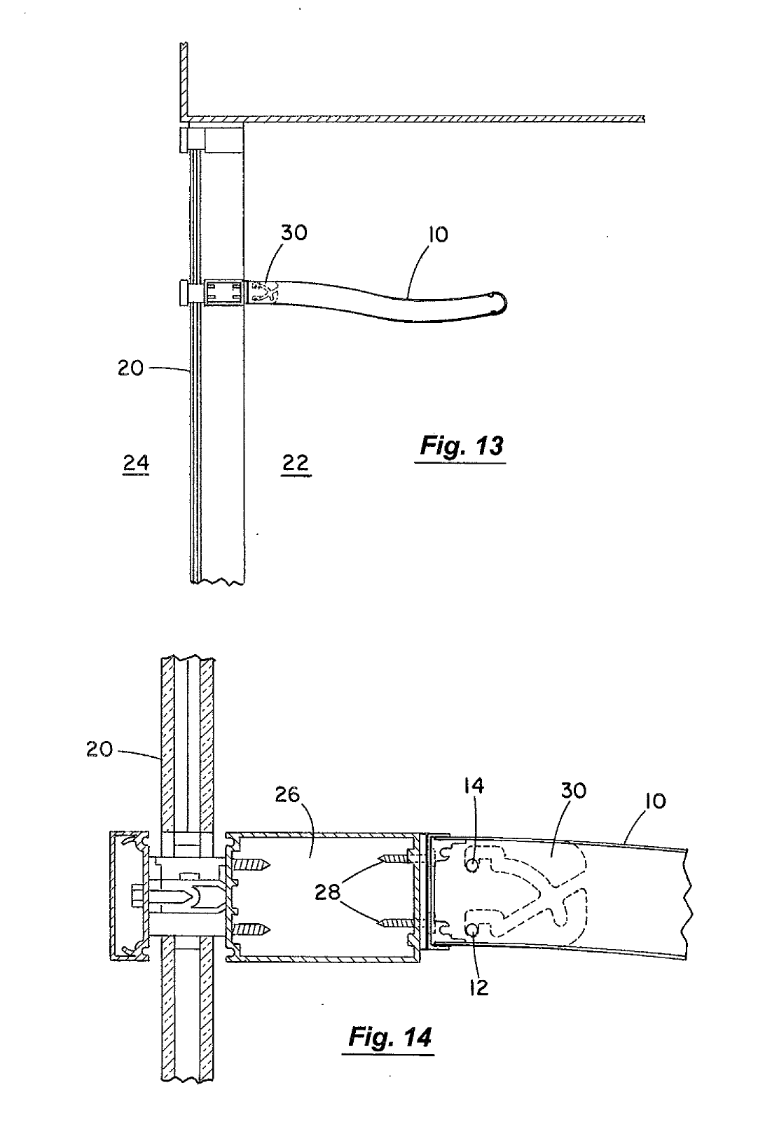

The mounting bracket 30 can also be equipped with a mechanism to positively lock the light shelf 10 in its horizontal position. One embodiment of this locking mechanism is depicted in FIGS. 1, 2 and 11-14. This includes two short horizontal track segments 45 and 55 where the pins 14, 12 have to go upwards, over, and then down into the locking stops 44, 54 to positively lock the light shelf 10 in its horizontal position. FIGS. 11 and 12 illustrate an upward, and then horizontal motion of the light shelf 10 along the horizontal track segments 45, 55. FIGS. 13 and 14 illustrate the light shelf 10 in its locked horizontal position. Here, the light shelf 10 is prevented from tilting or rotating downward. This is the position that is normally used for the mounting bracket 30, since all other positions are relatively temporary during initial installation or subsequent maintenance. This process can be reversed to unlock and lower the light shelf for maintenance, or to remove the light shelf 10 from the mounting bracket 10

The mounting bracket 30 can be attached to the building support member 26 by means of fasteners 28 (e.g., screws) extending through corresponding holes 32 in the base of the mounting bracket 30, as shown for example in FIG. 4. In areas where there is no support member 26 or other substrate located directly behind the mounting bracket 30, the fasteners 28 may extend through mounting holes in an ear of the mounting bracket 30. For example, in the case of right-hand or left-hand conditions, one ear of the mounting bracket 30 can have the track pattern cut out while the other ear has only mounting holes extending through it. The holes in the ear opposite to the tracks can be aligned with the tracks to permit easy installation using any of a variety of fasteners by providing access to the mounting holes for the fastener through the tracks. Mounting brackets of this type may be made in right or left hand configurations.

The present system is applicable to both new installations as well as installations to existing window glazing systems. The mounting brackets may also be mounted to a variety of support members 26 or other substrates such as concrete, wood studs, metal panels, stone, or virtually any flat substrate that will adequately support the loads imposed by the light shelf system.

It should be understood that the relative locations of the pins 12, 14 on the light shelf 10 and the tracks on the mounting brackets 30 could be reversed. In other words, the tracks could be located on the lateral edges or in intermediate recesses in the light shelf 10, and the pins could extend from the mounting brackets 30.

The pins 12, 14 on the light shelf 10 do not necessarily extend from the lateral edges of the light shelf 10. For example, the light shelf 10 could be attached by sets of pins extending across each of a plurality of intermediate recesses running from the exterior edge of the light shelf adjacent to the window. In this embodiment, the mounting brackets could be secured to mullions or vertical support members between adjacent windows.

For the purposes of this disclosure, the term “pin” should be broadly construed to include any type of protrusion suitable for sliding engagement with a track. Similarly, the term “track” should be broadly construed to include any type of elongated recess, protrusion or edge suitable for defining a path for sliding engagement with a pin.

These terms can be further generalized by saying that the light shelf 10 has at least one “light shelf connector” and the mounting bracket has at least one complementary “mounting bracket connector” that engages the light shelf connector to hold the light shelf 10 in its horizontal position and allow it to pivot downward for cleaning and maintenance. The tracks described above could serve as either the light shelf connector or the mounting bracket connector, while the pins could serve as the other.

The rotational light shelf clip system makes present-day light shelf technology more effective by making it easier to safely maintain such systems. There has been a need for a light shelf system that is easier to maintain with typical building maintenance personnel and procedures. The present system is simple to use, lightweight, and compact in design. The present system can also integrate a cover cap to ensure occupants or maintenance personnel do not get fingers caught in the track system. The tracks themselves should be small enough that an average person cannot get their fingers inside, and thereby avoid the risk of a pinch point. The present mounting bracket is robust and aesthetically and architecturally pleasing, while providing sufficient structural support to hold the light shelf in a horizontal position during normal use.

The above disclosure sets forth a number of embodiments of the present invention described in detail with respect to the accompanying drawings. Those skilled in this art will appreciate that various changes, modifications, other structural arrangements, and other embodiments could be practiced under the teachings of the present invention without departing from the scope of this invention as set forth in the following claims.

We claim:

1. A light shelf assembly comprising:
a light shelf with a top surface and a light shelf connector;
a mounting bracket for attachment to a building structure adjacent to a window, said mounting bracket having a mounting bracket connector for removably engaging the light shelf connector to attach the light shelf to the mounting bracket;
wherein one of the light shelf connector and mounting bracket connector include a first pin and a second pin extending laterally therefrom; and
wherein the other of the light shelf connector and mounting bracket connector include:
(a) a first track segment for initial insertion of the pins to engage the light shelf and mounting bracket; and
(b) a second track segment enabling the first pin to slide between a first position in which the light shelf is held in a substantially horizontal position, and a second position in which the light shelf pivots downward.

2. The light shelf assembly of claim 1 wherein the pins extend from a lateral edge of the light shelf, and the first and second track segments are on the mounting bracket.

3. The light shelf assembly of claim 1 further comprising a pivot stop along the first track segment for receiving the second pin, and wherein the second track segment enables the first pin to pivot about the second pin in the pivot stop by sliding between the first position and the second position.

4. The light shelf assembly of claim 1 further comprising locking stops receiving and holding the pins when the light shelf is in a substantially horizontal position.

5. A light shelf assembly comprising:
a light shelf with a top surface, a bottom surface, opposing lateral edges, and a first pin and a second pin extending laterally outward from a lateral edge; and
a mounting bracket for attachment to a building structure adjacent to a window, having:
(a) a first track segment for initial insertion of the pins into the mounting bracket; and
(b) a second track segment enabling the first pin to slide between a first position in which the light shelf is held in a substantially horizontal position, and a second position in which the light shelf pivots downward.

6. The light shelf assembly of claim 5 further comprising a pivot stop along the first track segment for receiving the second pin, and wherein the second track segment enables the first pin to pivot about the second pin in the pivot stop by sliding between the first position and the second position.

7. The light shelf assembly of claim 5 further comprising locking stops receiving and holding the pins when the light shelf is in a substantially horizontal position.

8. A light shelf assembly comprising:
a light shelf with a top surface, a bottom surface, opposing lateral edges, and a first pin and a second pin extending laterally outward from a lateral edge; and
a mounting bracket for attachment to a building structure adjacent to a window, having:
(a) a first track segment for initial insertion of the pins into the mounting bracket;
(b) a pivot stop along the first track segment for receiving the second pin; and
(c) a second track segment enabling the first pin to pivot about the second pin in the pivot stop, by sliding between a first position in which the light shelf is held in a substantially horizontal position and a second position in which the light shelf pivots downward.

9. The light shelf assembly of claim 8 further comprising locking stops receiving and holding the pins when the light shelf is in a substantially horizontal position.
